(19) United States
(12) Patent Application Publication
(10) Pub. No.: US 2013/0058706 A1
(43) Pub. Date: Mar. 7, 2013

(54) Unified universal rack connector

(71) Applicants: Paul Harris, Montreal (CA); Jerome D. Roy, St-Jean-de-Matha (CA)

(72) Inventors: Paul Harris, Montreal (CA); Jerome D. Roy, St-Jean-de-Matha (CA)

(73) Assignee: Kempter Marketing Inc., Dorval (CA)

(21) Appl. No.: 13/573,262

(22) Filed: Sep. 6, 2012

Related U.S. Application Data
(60) Provisional application No. 61/573,122, filed on Sep. 7, 2011.

(51) Int. Cl. F16D 1/00

(52) U.S. Cl. 403/3

(57) ABSTRACT

A unified bicycle rear rack connector which may comprise of two arms or strips extending from a first end securable to the rear rack, to a second end which is securable to a bike frame such that the two strips are capable of moving one over each other horizontally. Further, the two strips are joined by a fastener, such as a fastener is a nut and bolt combination, passing through overlapping holes in the two strips of the connector. Moreover, at least one of the overlapping holes is elongated to enable securing an increase or decrease of width of a connector surface parallel to the major plain of the connector that central bolt once tightened makes the assembly laterally stiff. Once the connector is fastened to the rear rack, the connector can move in a plastic fashion in a substantially vertical direction.

### CROSS REFERENCE TO RELATED APPLICATIONS

The present application claims the benefit under 35 U.S.C. section 119 (e) of U.S. Provisional Patent Application No. 61/573,122, titled “ Unified Universal Rack Connector”, filed Sep. 07, 2012, which is hereby incorporated by reference in its entirety.

### FIELD OF THE INVENTION

The present invention relates generally to a rear bicycle rack mount connector.

### BACKGROUND OF THE INVENTION

Rear Bicycle racks typically connected to seat stays via strips like structures that are fixed via nut and bolt or are an extension of the rear rack itself. These spokes are rigidly engaged to the seat stays. The inventors have recognized such arrangements are laterally flexible. Accordingly, the arrangement of rear rack assembly needs to be changed to account for this limitation.

### SUMMARY

The primary aspect of the invention is to provide a bicycle rear rack connector, the connector comprising two strips both extending from a first end securable to the rear rack, to a second end which is securable to seat stays or seat tube such that the two strips are capable of moving one over the other horizontally wherein the two strips can be joined by a fastener passing through overlapping holes in the two strips to fix a width of the rear rack connector and so form a unified assembly to reduce sideway flexion of the rack. Alternatively, the invention is a rack mounting plate that is a one piece connector giving greater lateral stiffness wherein the connector uses spacers for adjusting to different bicycle rack mount widths.

### BRIEF DESCRIPTION OF THE DRAWINGS

FIG. 1 shows a connector as part of bicycle viewed from the bottom

FIG. 2 shows a connector assembled

FIG. 3 shows connector 3D Axis adjustability

FIG. 4 shows connector flexion for vertical adjustability

FIG. 5 shows an alternative embodiment

FIG. 6 shows an alternative embodiment

FIG. 7 shows an alternative embodiment

FIG. 8 shows prior art independent connectors

### DETAILED DESCRIPTION

Preferred embodiments of the invention and its advantages can be understood by referring to the present drawings. Through all of the drawings the same reference numbers are used to refer to similar elements.

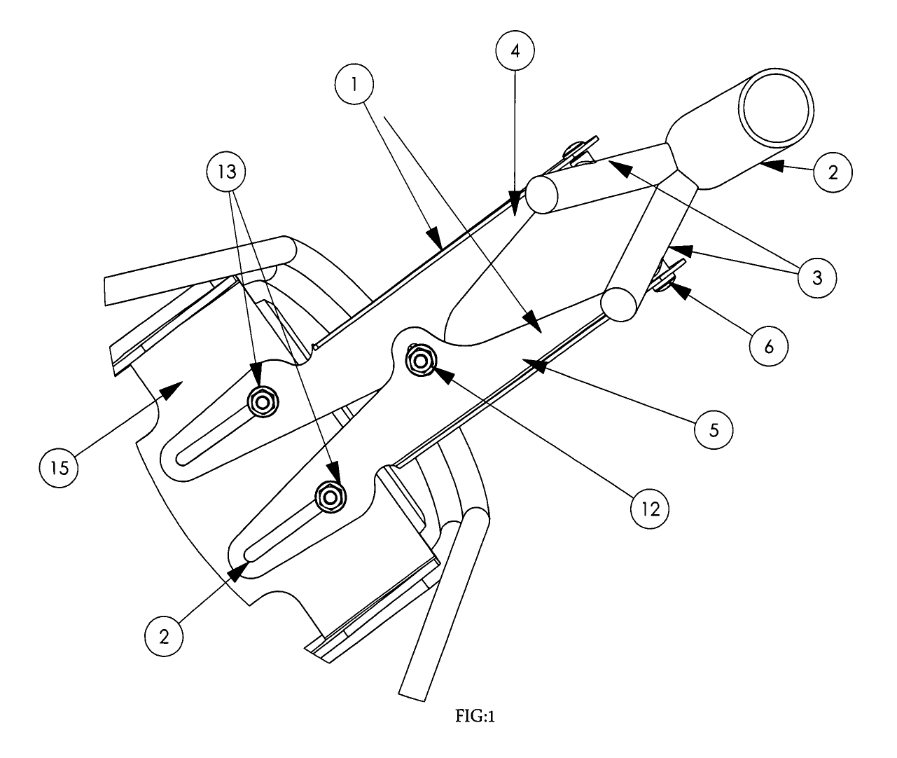

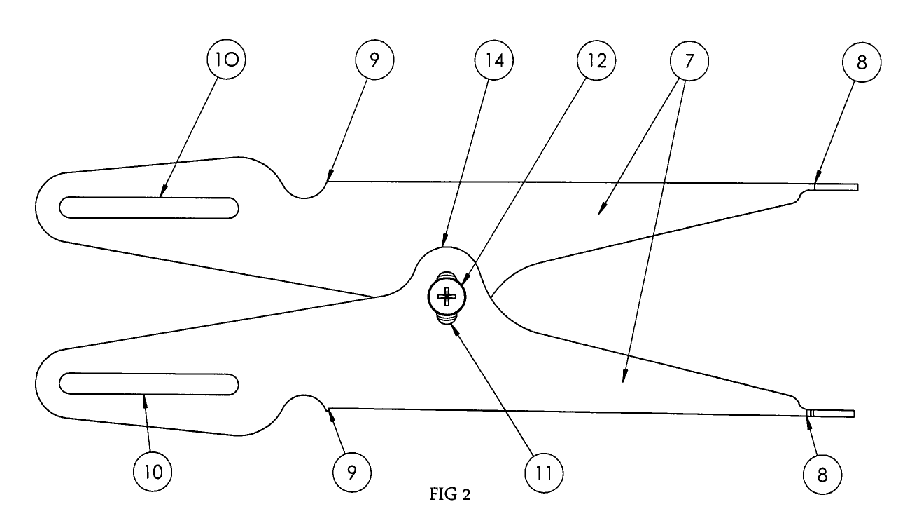

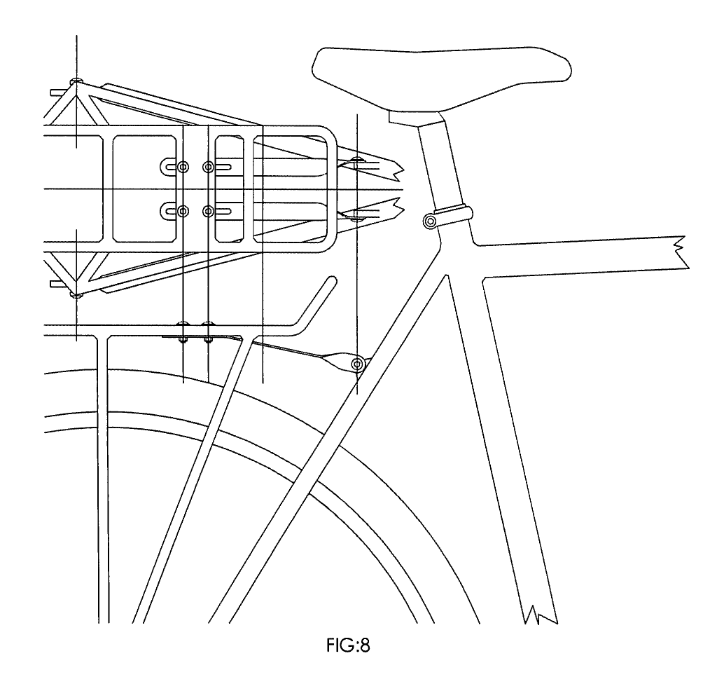

In one aspect of the invention, as shown in FIG. 1, a rear rack connector 1 that is engaged to the seat stays 3 attached to seat tube 2 of a bicycle. There are two connecting strips 4 and 5 that may enable engagement to the seat stays with screws. One such engagement is shown by 6 in FIG. 1. The upper plane of the connector as shown by FIG. 2 is comprised of two substantially triangular shaped surfaces 7 that extend from one edge 8 of the connector near the seat stays to the other end 9 of the connector near the rear rack. Each strip has a centre protrusion 14 with an elongated hole 11 to secure the strip to another strip at the opposite end. At the rack end, the connector is secured to the rear rack by two bolts in elongated holes 10. The connector width can expand or shrink since the two connecting strips are independent. The connecting strips 7 are pairs, held together by a central bolt 12 going through elongated holes 11 in each connector so one connecting strip can move one away from the other, to allow different frame seat stay mounting widths. Alternatively, the two strips FIG. 1, can move one over the other horizontally, enabled so by a spring mechanism. The pair can also move back and forth on the rack along the elongated holes 10 to keep the rack horizontal regardless of bicycle frame seat stay or seat tube attachment point. Once adjustment is done, the connector strips are tightened together by a central fastener 12 that makes the rack assembly laterally stiff as opposed to the independent connectors shown in FIG. 8, prior art.

In the preferred embodiment of the invention, as shown in FIG. 1, a rear rack connector 4 is shown securely attached to the rear rack 15 at one end 13 and attached with a fastener to seat stays 3 at the other end. In the preferred embodiment, the connector is securable to the rear rack with at least two nuts and bolts passing through elongated holes 10. However, it can be secured with some change of design with one nut and bolt combination or other securing means, including but not limited to, such as a rivet or a screw.

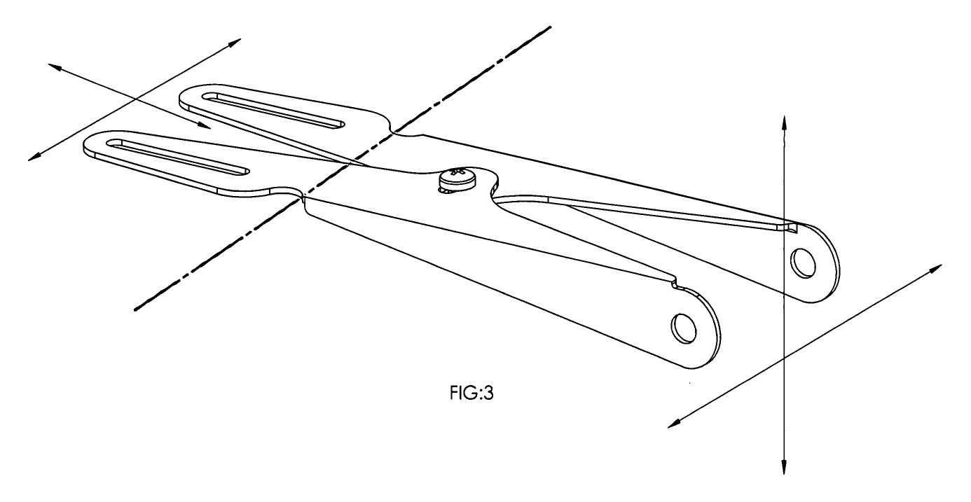

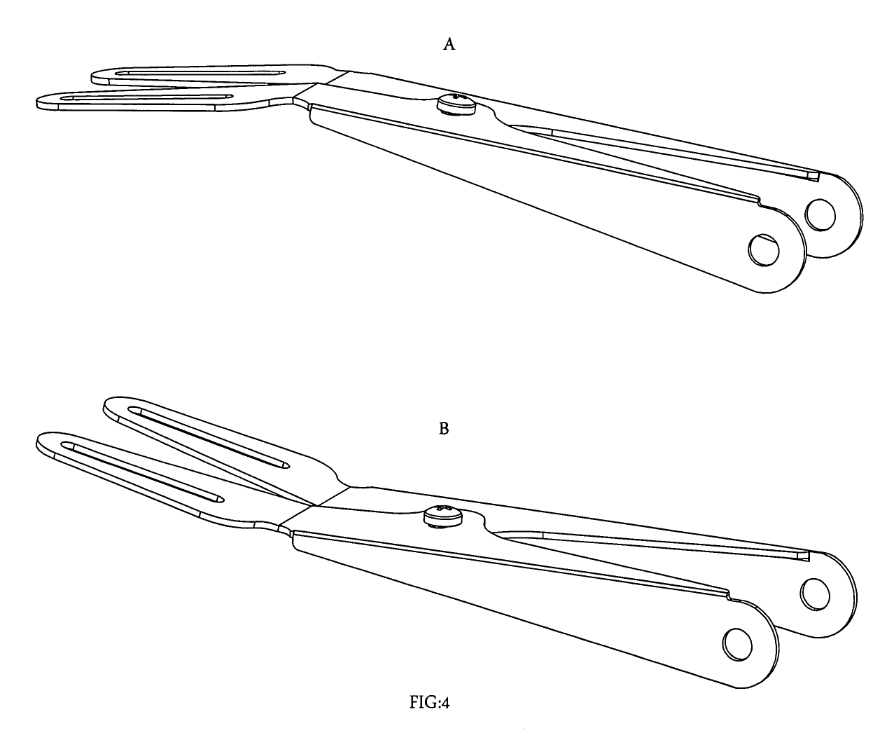

Once the connector is secured to the rear rack, the other end of the connector can be adjusted in a vertical direction in a plastic fashion as shown in FIGS. 4a and 4b to accommodate for a lower or higher connecting end of a seat stay or seat tube. Flexing occurs along the dotted line on FIG. 3. This motion combined with side to side and fore and aft adjustability mentioned earlier allows the connector three dimensional movement capability as shown by the arrows in FIG. 3. This 3-dimensional movement enables the connector to be reasonably adjusted in any of the 3-dimension and be used with bicycles having range bound different spatial separations between the rear rack 15 and seat stays 3.

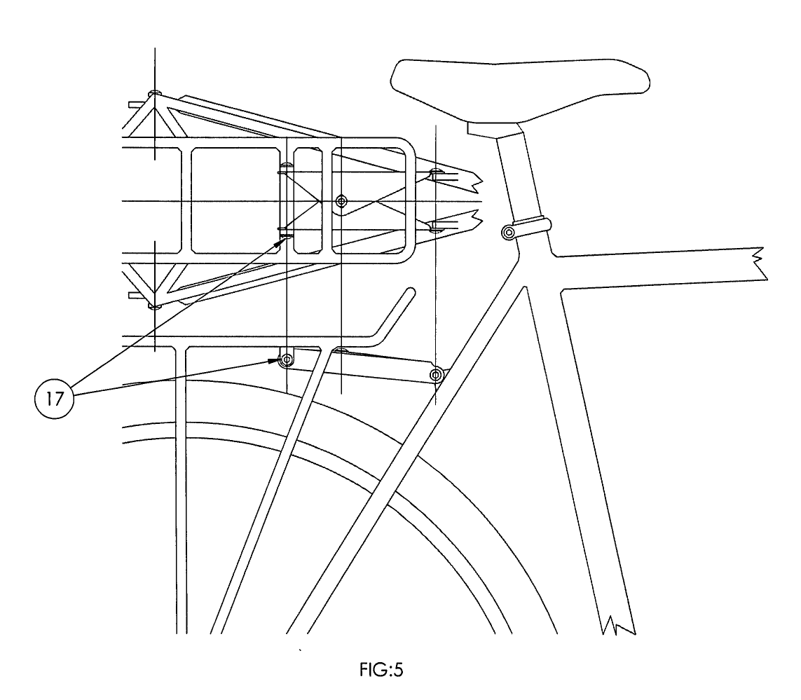

In alternate embodiment of the same invention as shown in FIG. 5, the connecting strips are secured to the rear rack in the same mechanism that allows the connecting strips to be attached to the seat stays. This allows a fastener 17 at the rear rack end enabling a semi circular motion of the connector. Such a rotation would replace the connector movement in a plastic fashion in a direction substantially vertical to the major plane of the rear rack.

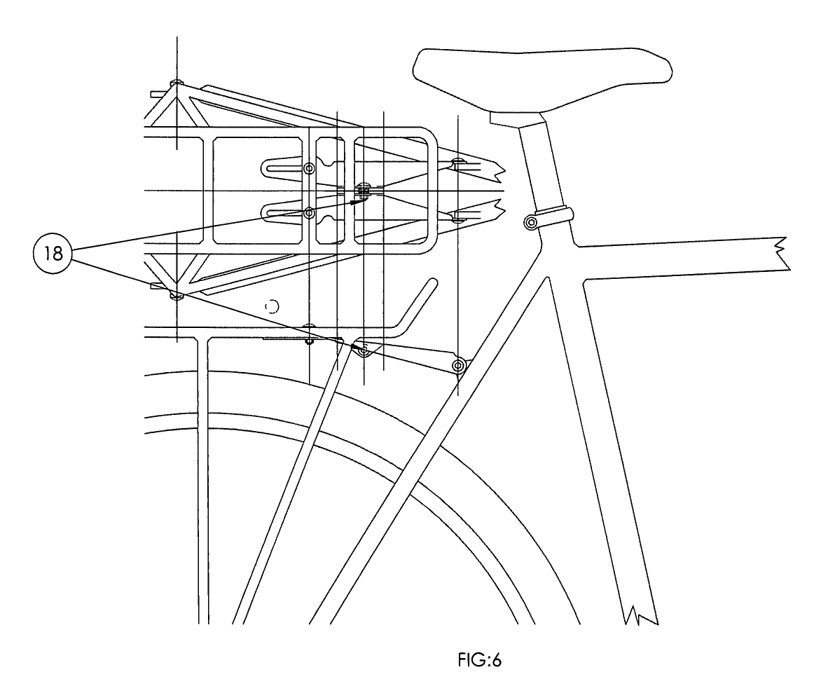

In another embodiment of the same invention as shown by FIG. 6 of the same invention, the connecting strips are L-shaped rectangles from one end connecting to the seat stays and the other connecting to the rear rack. Bicycle rack mount width can be adapted to using a washer stack on the central fastener 18.

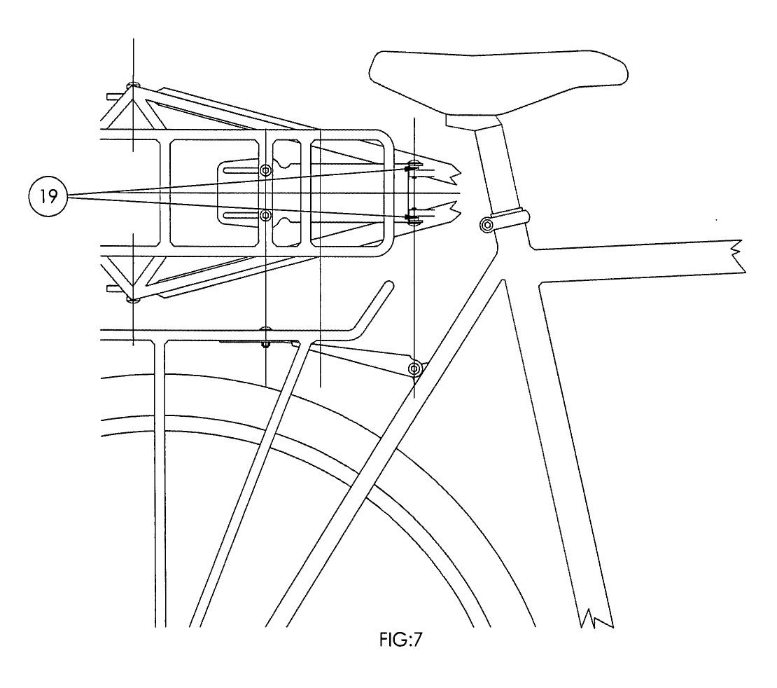

FIG. 7 shows an alternative embodiment where a one piece connector allows for different bicycle rack mount widths, using a washer stack 19 on each seat stay or seat tube attachment point. At the rack end the connector is secured to the rear rack by two bolts in elongated holes. The connector can thus move back and forth on the rack along these elongated holes to keep the rack horizontal regardless of bicycle frame seat stay placement or bicycle tube attachment point. Once the one piece connector is secured to the rear rack, the other end can be adjusted in a vertical direction in a plastic fashion to accommodate for a lower and higher connecting end of a seat stay or seat tube.

An equivalent description of the inventive concept may be a rack mounting plate that is a one piece connector giving greater lateral stiffness wherein the connector uses spacers for adjusting to different bicycle rack mount widths. Here the one piece construction and C-section of the connector gives it greater lateral stiffness to the whole rack assembly as compared to the separate strips of prior art. Further the connector is secured to a rear rack by fasteners using elongated holes in the connector enabling horizontal adjustment of distance between the rear rack and seat stays or seat tube. Once the connector is fastened to the rear rack the connector can move in a plastic fashion to allow fit to a different height bicycle rack mounts. As such, the horizontal adjustment and the movement in a plastic fashion allows for adjustability in two dimensions the washer stack being the third adjustment. Here it is worth noting that connection from connectors to rack may be made from the sides of a connector strip. Also, a vertical adjustment is provided by movement around the rear rack to a connector fastener axis.

It will be appreciated by those skilled in the art that other variations of the embodiments described herein may also be practiced without departing from the scope of the invention. Other modifications are therefore possible.

What is claimed is:

1. A bicycle rear rack connector, the connector comprising:
two strips both extending from a first end securable to the rear rack, to a second end which is securable to seat stays or seat tube such that the two strips are capable of moving one over the other horizontally wherein the two strips can be joined by a fastener passing through overlapping holes in the two strips to fix a width of the rear rack connector and so form a unified assembly to reduce sideway flexion of the rack.

2. The connector of claim 1, wherein a horizontal surface of a strip is shaped substantially like a triangle with a centre protrusion with an elongated hole to secure the strip to another strip at the opposite side.

3. The connector of claim 1, wherein at least one of the overlapping holes is elongated to enable securing an increase or decrease of the width of the rear rack connector.

4. The connector of claim 1, where the fastener is a nut and bolt combination that allows adjustment when loose and stiffens the assembly when tight.

5. The connector of claim 1, wherein sides of the two strips are folded at right angles with holes such that the strips can be secured to the seat stays or seat tube by a nut and bolt combination.

6. The connector of claim 1, wherein once the connector is fastened to the rear rack, the connector can move in a plastic fashion to allow fit to different heights of bicycle mount location.

7. The connector of claim 1, wherein the two strips are secured to the rear rack by fasteners using elongated holes in the two strips enabling horizontal adjustment of distance between the rear rack and seat stays or seat tube.

8. The connector of claim 1, wherein the two strips can move one over the other horizontally enabled by a spring mechanism.

9. The connector of claim 1, wherein the connector strips have a C Section, and where the two connectors are fastened together by a bolt going through the inner folded sides. The width of the assembly can be changed by adding or removing spacer held by this central bolt between the connecting strips.

10. The connector of claim 1, wherein the connection from connectors to rack are made from the sides of a connector strip.

11. The connector of claim 1, such that a vertical adjustment is provided by movement around the rear rack to a connector fastener axis.

12. A rack mounting plate that is a one piece connector giving greater lateral stiffness wherein the connector uses spacers for adjusting to different bicycle rack mount widths.

13. The connector of claim 12, wherein the one piece construction and C section of the connector gives greater lateral stiffness to the whole rack assembly.

14. The connector of claim 12, wherein the connector is secured to a rear rack by fasteners using elongated holes in the connector enabling horizontal adjustment of distance between the rear rack and seat stays or seat tube.

15. The connector of claim 12 wherein once the connector is fastened to the rear rack the connector can move in a plastic fashion to allow fit to a different height bicycle rack mounts.

16. The connector of claim 12, wherein that the horizontal adjustment and the move in a plastic fashion allows adjustability in two dimensions.

17. The connector of claim 12, wherein the connection from connectors to rack are made from the sides of a connector strip.

18. The connector of claim 12, such that a vertical adjustment is provided by movement around the rear rack connector fastener axis.
